(19) United States
(12) Patent Application Publication
(10) Pub. No.: US 2025/0158641 A1
(43) Pub. Date: May 15, 2025

(54) ANTENNA MODULE AND FRONT END CIRCUIT INCLUDED IN ANTENNA MODULE

(71) Applicant: Murata Manufacturing Co., Ltd., Nagaokakyo-shi, Kyoto (JP)

(72) Inventor: Hidefumi OHIRA, Nagaokakyo-shi (JP)

(73) Assignee: Murata Manufacturing Co., Ltd., Nagaokakyo-shi, Kyoto (JP)

(21) Appl. No.: 19/019,572

(22) Filed: Jan. 14, 2025

Related U.S. Application Data
(63) Continuation of application No. PCT/JP2023/012245, filed on Mar. 27, 2023.

(30) Foreign Application Priority Data
Jul. 15, 2022 (JP) 2022-113926

(51) Int. Cl. H04B 1/00; H04B 1/04

(52) U.S. Cl. CPC H04B 1/006; H04B 1/0067; H04B 1/0483

(57) ABSTRACT

An antenna module includes radio frequency circuits and a front end circuit that transfers a signal between a BBIC and the radio frequency circuits. The front end circuit includes switches that are connected to the radio frequency circuits, switches that are connected to the BBIC, and branching elements. The front end circuit is configured to, by switching of each of the switches, switch between a first state in which a signal is transferred between one of the radio frequency circuit and the radio frequency circuit and the BBIC and a second state in which a signal is transferred between both the radio frequency circuits and the BBIC.

### CROSS-REFERENCE TO RELATED APPLICATIONS

This is a continuation application of PCT/JP2023/012245, filed on Mar. 27, 2023, designating the United States of America, which is based on and claims priority to Japanese Patent Application No. JP 2022-113926 filed on Jul. 15, 2022. The entire contents of the above-identified applications, including the specifications, drawings and claims, are incorporated herein by reference in their entirety.

### TECHNICAL FIELD

The present disclosure relates to an antenna module and a front end circuit included in the antenna module, and more particularly, to an antenna module capable of efficiently selecting an antenna element.

### BACKGROUND ART

In recent years, for portable terminals such as mobile phones and smartphones, development of multi-band communications in which transmission and reception is performed using radio waves in a plurality of frequency bands has been advanced. Furthermore, configurations in which a plurality of antenna panels are disposed in an apparatus in order that transmission and reception of radio waves is performed in different directions have been contemplated.

In U.S. Patent Application Publication No. 2020/0252115 (Patent Document 1), a configuration of a MIMO (Multiple-Input Multiple-Output) antenna including a plurality of antenna elements is disclosed in which in order that transmission and reception of radio waves in one or both of different two frequency bands is performed, antenna elements to be used for individual frequency bands are selected using a splitter/combiner and a weighting circuit that are provided inside a radio frequency circuit.

### CITATION LIST

### Patent Document

Patent Document 1: U.S. Patent Application Publication No. 2020/0252115

### SUMMARY OF DISCLOSURE

### Technical Problem

In the case where transmission and reception of radio waves in a plurality of frequency bands is performed and in the case where transmission and reception is performed using a plurality of antenna panels, a configuration in which a circuit on a radio frequency (Radio Frequency: RF) side is connected in a fixed manner to a circuit on a baseband (Base Band: BB) side has been typically adopted. Therefore, with such a configuration, it is difficult to increase transmission power and improve reception sensitivity by connecting a single baseband circuit to a plurality of antenna panels.

With the configuration in U.S. Patent Application Publication No. 2020/0252115 (Patent Document 1), a desired antenna element can be selected. However, since a signal is also supplied to a radio frequency circuit of an antenna element that is not to be used, unwanted power consumption may occur.

The present disclosure has been designed to solve the problem mentioned above, and an object of the present disclosure is to suppress unwanted power consumption and to efficiently select an antenna element to be used for transmission and reception in an antenna module that performs transmission and reception using a plurality of antenna panels.

### Solution to Problem

An antenna module according to a first aspect of the present disclosure transmits and receives a signal to and from a baseband circuit. The antenna module includes a plurality of radio frequency circuits each including at least one antenna element, and a front end circuit that transfers a signal between the baseband circuit and the plurality of radio frequency circuits. The front end circuit includes a first switch circuit that is connected to the plurality of radio frequency circuits, a second switch circuit that is connected to the baseband circuit, and a first branching circuit that is connected between the first switch circuit and the second switch circuit. The plurality of radio frequency circuits include a first radio frequency circuit and a second radio frequency circuit. The front end circuit is configured to, by switching of the first switch circuit and the second switch circuit, switch between a first state in which a signal is transferred between one of the first radio frequency circuit and the second radio frequency circuit and the baseband circuit and a second state in which a signal is transferred between both the first radio frequency circuit and the second radio frequency circuit and the baseband circuit.

A front end circuit according to a first aspect of the present disclosure transfers a signal between a baseband circuit and a plurality of radio frequency circuits. The front end circuit includes a first switch circuit that is connected to the plurality of radio frequency circuits, a second switch circuit that is connected to the baseband circuit, and a first branching circuit that is connected between the first switch circuit and the second switch circuit. The plurality of radio frequency circuits include a first radio frequency circuit and a second radio frequency circuit. The front end circuit is configured to, by switching of the first switch circuit and the second switch circuit, switch between a first state in which a signal is transferred between one of the first radio frequency circuit and the second radio frequency circuit and the baseband circuit and a second state in which a signal is transferred between both the first radio frequency circuit and the second radio frequency circuit and the baseband circuit.

### Advantageous Effects of Disclosure

With an antenna module and a front end circuit according to the present disclosure, in the antenna module including a plurality of radio frequency circuits (antenna panels), a radio frequency circuit that is to be used for transmission and reception can be selected using the front end circuit including a switch circuit and a branching circuit. With the configuration mentioned above, a radio frequency circuit to be used can be selected in a desired manner, and transmission of a radio frequency signal to a radio frequency circuit that is not to be used can be prevented. Thus, unwanted power consumption can be suppressed, and an antenna element to be used for transmission and reception can be selected efficiently.

### BRIEF DESCRIPTION OF DRAWINGS

FIG. 1 is a block diagram of a communication apparatus in which an antenna module according to a first embodiment is used.

FIG. 2 is a block diagram of a communication apparatus in which an antenna module according to a second embodiment is used.

FIG. 3 is a block diagram of a communication apparatus in which an antenna module according to a third embodiment is used.

FIG. 4 is a block diagram of a communication apparatus in which an antenna module according to a fourth embodiment is used.

FIG. 5 is a block diagram of a communication apparatus including a front end circuit according to a first modification.

FIG. 6 is a block diagram of a communication apparatus including a front end circuit according to a second modification.

FIG. 7 is a block diagram of a communication apparatus in which an antenna module according to a first example of a fifth embodiment is used.

FIG. 8 is a block diagram of a communication apparatus in which an antenna module according to a second example of the fifth embodiment is used.

### DESCRIPTION OF EMBODIMENTS

Hereinafter, embodiments of the present disclosure will be described in detail with reference to drawings. The same or corresponding parts in drawings are denoted by the same signs and description of those parts will not be repeated.

### First Embodiment

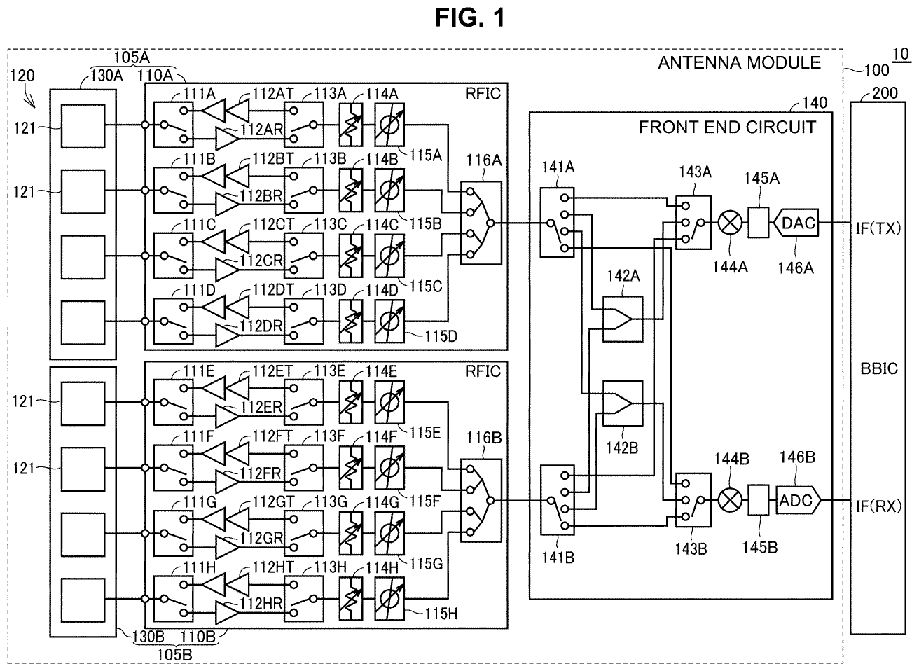

FIG. 1 is a block diagram of a communication apparatus 10 in which an antenna module 100 according to a first embodiment is used. Referring to FIG. 1, the communication apparatus 10 includes, in addition to the antenna module 100, a BBIC 200 configuring a baseband signal processing circuit. The antenna module 100 includes RFICs 110A and 110B, a front end circuit 140, and an antenna apparatus 120. In the communication apparatus 10, a signal transmitted from the BBIC 200 to the antenna module 100 is up-converted into a radio frequency signal and the radio frequency signal is radiated from the antenna apparatus 120. In addition, a radio frequency signal received by the antenna apparatus 120 is down-converted and is then processed by the BBIC 200.

The antenna apparatus 120 includes dielectric substrates 130A and 130B at which a plurality of antenna elements 121 are disposed. Although an example in which four antenna elements 121 are disposed at each dielectric substrate is illustrated in FIG. 1, the number of antenna elements 121 disposed at each dielectric substrate is not limited to this example. The number of antenna elements 121 may be two or more and is not necessarily four. Alternatively, a single antenna element 121 may be disposed at a dielectric substrate. Furthermore, in the case where each dielectric substrate includes a plurality of antenna elements 121, the antenna elements 121 may be disposed in a one-dimensional array as in FIG. 1 or may be disposed in a two-dimensional array.

In an embodiment of the present disclosure, a patch antenna having a substantially rectangular (square) flat plate shape is described as an example of an antenna element 121. However, the shape of an antenna element 121 may be a circular shape, an oval shape, or a polygonal shape other than a rectangular shape. Furthermore, the antenna element 121 may be a linear antenna such as a monopole antenna or a dipole antenna.

In the description provided below, a dielectric substrate at which an antenna element is disposed will also be referred to as an “antenna panel.” Furthermore, the combination of an RFIC and an antenna panel will also be referred to as a “radio frequency circuit.” For example, the RFIC 110A and the dielectric substrate 130A at which the antenna elements 121 are disposed form a radio frequency circuit 105A. Similarly, the RFIC 110B and the dielectric substrate 130B at which the antenna elements 121 are disposed form a radio frequency circuit 105B. Furthermore, the RFICs 110A and 110B and the like will also be comprehensively referred to as “RFICs 110” and the dielectric substrates 130A and 130B and the like will also be comprehensively referred to as “dielectric substrates 130.” Furthermore, the radio frequency circuits 105A and 105B and the like will also be comprehensively referred to as “radio frequency circuits 105.”

The RFIC 110A includes switches 111A to 111D and 113A to 113D, power amplifiers 112AT to 112DT, low noise amplifiers 112AR to 112DR, attenuators 114A to 114D, phase shifters 115A to 115D, and a signal combiner/splitter 116A. Furthermore, the RFIC 110B includes switches 111E to 111H and 113E to 113H, power amplifiers 112ET to 112HT, low noise amplifiers 112ER to 112HR, attenuators 114E to 114H, phase shifters 115E to 115H, and a signal combiner/splitter 116B.

In the case of transmission of radio frequency signals, the switches 111A to 111H and 113A to 113H are switched toward the power amplifiers 112AT to 112HT side. In the case of reception of radio frequency signals, the switches 111A to 111H and 113A to 113H are switched toward the low noise amplifiers 112AR to 112HR side.

In the RFICs 110A and 110B, signals transmitted from the BBIC 200 through the front end circuit 140 are split into four signals by the signal combiner/splitters 116A and 116B, travel through four signal paths, and are supplied to different antenna elements 121. At this time, degrees of phase shift of the phase shifters 115A to 115H disposed at individual signal paths are adjusted individually, and the directivity of the antenna apparatus 120 can thus be adjusted. Furthermore, the attenuators 114A to 114H adjust strengths of transmission signals.

Reception signals, which are radio frequency signals received at the individual antenna elements 121, travel through different four signal paths in corresponding RFICs and are combined at the signal combiner/splitters 116A and 116B. The combined reception signals travel through the front end circuit 140 and are transmitted to the BBIC 200.

The front end circuit 140 performs frequency conversion of a signal transmitted from the BBIC 200 and signals received by the radio frequency circuits 105 and selects a radio frequency circuit 105 to be used for transmission and reception. The front end circuit 140 includes switches 141A, 141B, 143A, and 143B, branching elements (dividers) 142A and 142B, mixers 144A and 144B, filters 145A and 145B, a digital/analog converter (DAC) 146A, and an analog/digital converter (ADC) 146B. Each of the branching elements 142A and 142B includes a first terminal and second and third terminals that branch off from the first terminal.

In the front end circuit 140, the switch 143A, the mixer 144A, the filter 145A, and the DAC 146A are elements that are used to radiate radio waves from the antenna apparatus 120. Furthermore, the switch 143B, the mixer 144B, the filter 145B, and the ADC 146B are elements that are used to receive radio waves at the antenna apparatus 120.

In the case of radiation of a radio wave from the antenna apparatus 120, the front end circuit 140 receives an intermediate frequency signal IF (TX) from the BBIC 200, which is a transmission signal, at the DAC 146A. The DAC 146A converts the intermediate frequency signal IF (TX) into an analog signal. The filter 145A eliminates signals at frequencies outside the pass band thereof from converted analog signals. The mixer 144A converts a signal that has passed through the filter 145A into a radio frequency signal by up-conversion using a signal from a local oscillator, which is not illustrated in the drawing, and outputs the radio frequency signal to the switch 143A.

The switch 143A is an SP3T switch and includes a common terminal and three switching terminals. The common terminal of the switch 143A is connected to the mixer 144A. The first switching terminal of the switch 143A is directly connected to the switch 141A. The third switching terminal of the switch 143A is directly connected to the switch 141B.

The second switching terminal of the switch 143A is connected to the first terminal of the branching element 142A. The second terminal of the branching element 142A, which branches off from the first terminal thereof, is connected to the switch 141A, and the third terminal of the branching element 142A is connected to the switch 141B. That is, the branching element 142A splits a signal from the switch 143A and distributes the signals to the switches 141A and 141B.

Each of the switches 141A and 141B is an SPAT switch and includes a common terminal and four switching terminals. The common terminal of the switch 141A is connected to the signal combiner/splitter 116A of the RFIC 110A. The first switching terminal of the switch 141A is connected to the first terminal of the switch 143A. The second switching terminal of the switch 141A is connected to the second terminal of the branching element 142A. The third switching terminal of the switch 141A is connected to the second terminal of the branching element 142B. The fourth switching terminal of the switch 141A is connected to the first terminal of the switch 143B.

Similarly, the common terminal of the switch 141B is connected to the signal combiner/splitter 116B of the RFIC 110B. The first switching terminal of the switch 141B is connected to the third terminal of the switch 143A. The second switching terminal of the switch 141B is connected to the third terminal of the branching element 142A. The third switching terminal of the switch 141B is connected to the third terminal of the branching element 142B. The fourth switching terminal of the switch 141B is connected to the third terminal of the switch 143B.

The first terminal of the branching element 142B is connected to the second terminal of the switch 143B.

By switching to the first switching terminal of the switch 143A and switching to the first switching terminal of the switch 141A, an up-converted signal from the BBIC 200 is transmitted only to the radio frequency circuit 105A. By switching to the second switching terminal of the switch 143A and switching to the second switching terminals of the switches 141A and 141B, a signal from the BBIC 200 is transmitted to both the radio frequency circuits 105A and 105B. By switching to the third switching terminal of the switch 143A and switching to the first switching terminal of the switch 141B, a signal from the BBIC 200 is transmitted only to the radio frequency circuit 105B. Thus, in the case of radiation of a radio wave from the antenna apparatus 120, by switching the switches 141A, 141B, and 143A as described above, a radio frequency circuit to be used for radiation can be selected.

In contrast, in the case of reception of a radio wave at the antenna apparatus 120, by switching to the fourth switching terminal of the switch 141A and switching to the first switching terminal of the switch 143B, only a signal from the radio frequency circuit 105A is transmitted to the switch 143B. By switching to the third switching terminals of the switches 141A and 141B and switching to the second switching terminal of the switch 143B, signals from both the radio frequency circuits 105A and 105B are transmitted to the switch 143B. By switching to the fourth switching terminal of the switch 141B and switching to the third switching terminal of the switch 143B, only a signal from the radio frequency circuit 105B is transmitted to the switch 143B. Thus, in the case of radiation of a radio wave from the antenna apparatus 120, by switching the switches 141A, 141B, and 143B as described above, a radio frequency circuit to be used for reception can be selected.

The common terminal of the switch 143B is connected to the mixer 144B. The mixer 144B converts a reception signal that has been transmitted to the switch 143B into an intermediate frequency signal by down-conversion using a signal from a local oscillator, which is not illustrated in the drawing. The filter 145B eliminates signals at frequencies outside the pass band thereof from down-converted reception signals. The ADC 146B converts a signal that has passed through the filter 145B into a digital signal and outputs the digital signal as an intermediate frequency signal IF (RX) to the BBIC 200. The BBIC 200 processes the received intermediate frequency signal IF (RX).

As described above, by providing a front end circuit including a switch circuit and a branching circuit between the baseband circuit and radio frequency circuits, switching between a first state in which one of the two radio frequency circuits (antenna panels) is used to perform transmission and reception and a second state in which both the radio frequency circuits are used to perform transmission and reception can be performed. Furthermore, in the case of radiation of radio waves, since no radio frequency signal is transmitted to a radio frequency circuit that is not to be used for transmission, unnecessary power consumption can be reduced.

With reference to FIG. 1, the case of an antenna module of a single band type in which an antenna element is associated with a single frequency band has been described. However, for example, with a configuration of antenna module of a multi-band type capable of transmitting and receiving radio frequency signals to and from antenna elements of multiple frequency bands using the same power feed lines, transmission and reception of radio waves in multiple frequency bands can be performed using the configuration in FIG. 1 by switching to a frequency band for processing in the baseband circuit.

In FIG. 1, the configuration in which the front end circuit and the RFICs are separated from each other is described. However, the front end circuit may be incorporated into the RFICs.

The “switches 141A and 141B” in the first embodiment correspond, as a whole, to a “first switch circuit” in the present disclosure, the “switch 141A” corresponds to a “first switch”, and the “switch 141B” corresponds to a “second switch.” The “switches 143A and 143B” in the first embodiment correspond, as a whole, to a “second switch circuit” in the present disclosure, the “switch 143A” corresponds to a “transmission switch”, and the “switch 143B” corresponds to a “reception switch.” The “radio frequency circuit 105A” and the “radio frequency circuit 105B” in the first embodiment correspond to a “first radio frequency circuit” and a “second radio frequency circuit”, respectively, in the present disclosure. The “branching elements 142A and 142B” in the first embodiment correspond, as a whole, to a “branching circuit” in the present disclosure, the “branching element 142A” corresponds to a “first branching element”, and the “branching element 142B” corresponds to a “second branching element.” The “mixer 144A” and the “mixer 144B” in the first embodiment correspond to a “first mixer circuit” and a “second mixer circuit”, respectively, in the present disclosure.

### Second Embodiment

In the first embodiment, a configuration for the case where two antenna panels are used to perform transmission and reception has been described. In a second embodiment, a configuration of an antenna module for the case where four antenna panels are used to perform transmission and reception will be described.

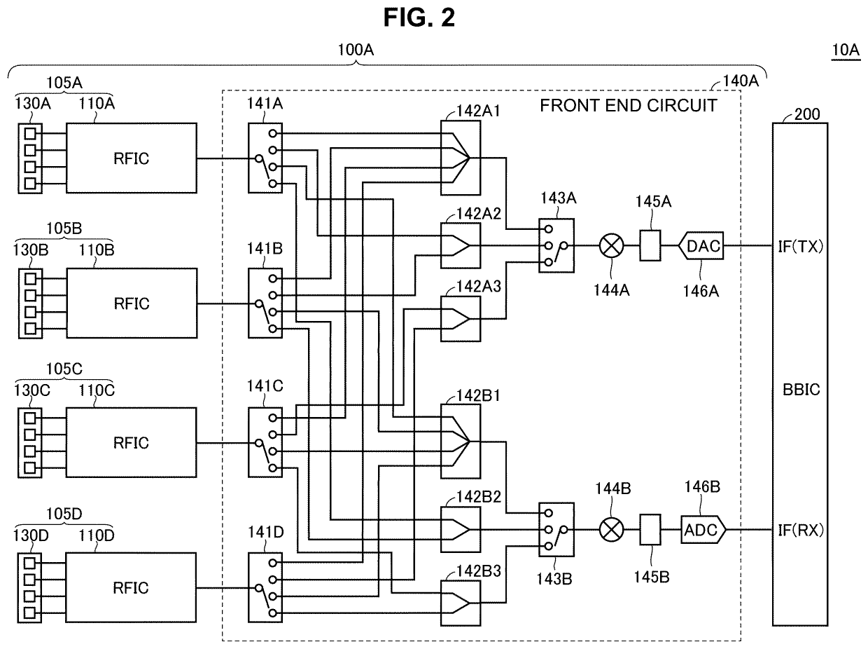

FIG. 2 is a block diagram of a communication apparatus 10A in which an antenna module 100A according to the second embodiment is used. The communication apparatus 10A has a configuration in which the antenna module 100 according to the first embodiment is replaced by the antenna module 100A. The antenna module 100A includes four radio frequency circuits 105A to 105D and a front end circuit 140A.

Each of the radio frequency circuits 105A to 105D has a configuration similar to the configurations of the radio frequency circuits 105A and 105B in the first embodiment, and detailed description of the configuration of each of the radio frequency circuits 105A to 105D will be omitted. The radio frequency circuit 105A includes the RFIC 110A and the dielectric substrate 130A at which the antenna elements 121 are disposed. The radio frequency circuit 105B includes the RFIC 110B and the dielectric substrate 130B at which the antenna elements 121 are disposed. The radio frequency circuit 105C includes an RFIC 110C and a dielectric substrate 130C at which the antenna elements 121 are disposed. The radio frequency circuit 105D includes an RFIC 110D and a dielectric substrate 130D at which the antenna elements 121 are disposed.

The front end circuit 140A includes four switches 141A to 141D and six branching elements 142A1 to 142A3 and 142B1 to 142B3, in addition to the switches 143A and 143B, the mixers 144A and 144B, the filters 145A and 145B, the DAC 146A, and the ADC 146B in the front end circuit 140 according to the first embodiment. Regarding the configuration in FIG. 2, description of the same elements as those in the first embodiment in FIG. 1 will not be repeated.

Each of the switches 141A to 141D is an SP4T switch and includes a common terminal and four switching terminals, as in the first embodiment. The switches 141A to 141D are provided in association with the radio frequency circuits 105A to 105D and the common terminals are connected to the corresponding RFICs.

Each of the branching elements 142A2, 142A3, 142B2, and 142B3 is configured to branch off into two paths, as with the branching elements 142A and 142B in the first embodiment, and includes a first terminal and second and third terminals that branch off from the first terminal. Each of the branching elements 142A1 and 142B1 is an element that is configured to branch off into four paths. Each of the branching elements 142A1 and 142B1 includes a fourth terminal and fifth to eighth terminals that branch off from the fourth terminal.

First, a circuit on a transmission side will be described. The first switching terminal of the switch 143A on the transmission side is connected to the fourth terminal of the branching element 142A1. The fifth to eighth terminals of the branching element 142A1 are connected to the first switching terminals of the switches 141A to 141D, respectively. That is, by switching to the first switching terminals of the switch 143A and the switches 141A to 141D, radio waves can be radiated from the four radio frequency circuits 105A to 105D.

The second switching terminal of the switch 143A is connected to the first terminal of the branching element 142A2. The second terminal of the branching element 142A2 is connected to the second switching terminal of the switch 141A, and the third terminal of the branching element 142A2 is connected to the second switching terminal of the switch 141B. That is, by switching to the second switching terminals of the switch 143A and the switches 141A and 141B, radio waves can be radiated from the two radio frequency circuits 105A and 105B.

The third switching terminal of the switch 143A is connected to the first terminal of the branching element 142A3. The second terminal of the branching element 142A3 is connected to the second switching terminal of the switch 141C, and the third terminal of the branching element 142A3 is connected to the second switching terminal of the switch 141D. That is, by switching to the third switching terminal of the switch 143A and switching to the second switching terminals of the switches 141C and 141D, radio waves can be radiated from the two radio frequency circuits 105C and 105D.

Next, a circuit on a reception side will be described. The first switching terminal of the switch 143B on the reception side is connected to the fourth terminal of the branching element 142B1. The fifth to eighth terminals of the branching element 142B1 are connected to the third switching terminals of the switches 141A to 141D, respectively. That is, by switching to the first switching terminal of the switch 143B and switching to the third switching terminals of the switches 141A to 141D, radio waves from the four radio frequency circuits 105A to 105D can be received.

The second switching terminal of the switch 143B is connected to the first terminal of the branching element 142B2. The second terminal of the branching element 142B2 is connected to the fourth switching terminal of the switch 141A, and the third terminal of the branching element 142B2 is connected to the fourth switching terminal of the switch 141B. That is, by switching to the second switching terminal of the switch 143B and switching to the fourth switching terminals of the switches 141A and 141B, radio waves from the two radio frequency circuits 105A and 105B can be received.

The third switching terminal of the switch 143B is connected to the first terminal of the branching element 142B3. The second terminal of the branching element 142B3 is connected to the fourth switching terminal of the switch 141C, and the third terminal of the branching element 142B3 is connected to the fourth switching terminal of the switch 141D. That is, by switching to the third switching terminal of the switch 143B and switching to the fourth switching terminals of the switches 141C and 141D, radio waves from the two radio frequency circuits 105C and 105D can be received.

As described above, by switching the switches 141A to 141D and the switches 143A and 143B, switching between the case where the four radio frequency circuits 105A to 105D are used to perform transmission and reception and the case where the two radio frequency circuits 105A and 105B or the two radio frequency circuits 105C and 105D are used to perform transmission and reception can be performed in an appropriate manner. In other words, for example, switching between a first state in which one of the pair of the radio frequency circuit 105A and the radio frequency circuit 105B and the pair of the radio frequency circuit 105C and the radio frequency circuit 105D is used to perform transmission and reception and a second state in which both the pairs of the radio frequency circuits are used to perform transmission and reception can be performed. Thus, transmission and reception of radio waves toward a desired direction can be performed, and at the same time, an increase in the transmission power toward a specific direction and an improvement of the reception sensitivity can be achieved.

In FIG. 2, the pair of the radio frequency circuits 105A and 105B and the pair of the radio frequency circuits 105C and 105D are illustrated as examples of combinations of two radio frequency circuits. However, the combinations of the pair of the radio frequency circuits 105A and 105C and the pair of the radio frequency circuits 105B and 105D or the combination of the pair of the radio frequency circuits 105A and 105D and the pair of the radio frequency circuits 105B and 105C may be made.

The “switches 141A to 141D” in the second embodiment correspond, as a whole, to a “first switch circuit” in the present disclosure, and the “switches 141A, 141B, 141C, and 141D” correspond to “first to fourth switches”, respectively, in the present disclosure. The “branching elements 142A1 to 142A3 and 142B1 to 142B3” in the second embodiment correspond, as a whole, to a “branching circuit” in the present disclosure, the “branching elements 142A2, 142B2, 142A3, and 142B3” correspond to “first to fourth branching elements”, respectively, in the present disclosure, and the “branching elements 142A1 and 142B1” correspond to a “fifth branching element” and a “sixth branching element”, respectively, in the present disclosure.

### Third Embodiment

In a third embodiment, a configuration for the case where two antenna panels and two baseband circuits are used to perform transmission and reception will be described.

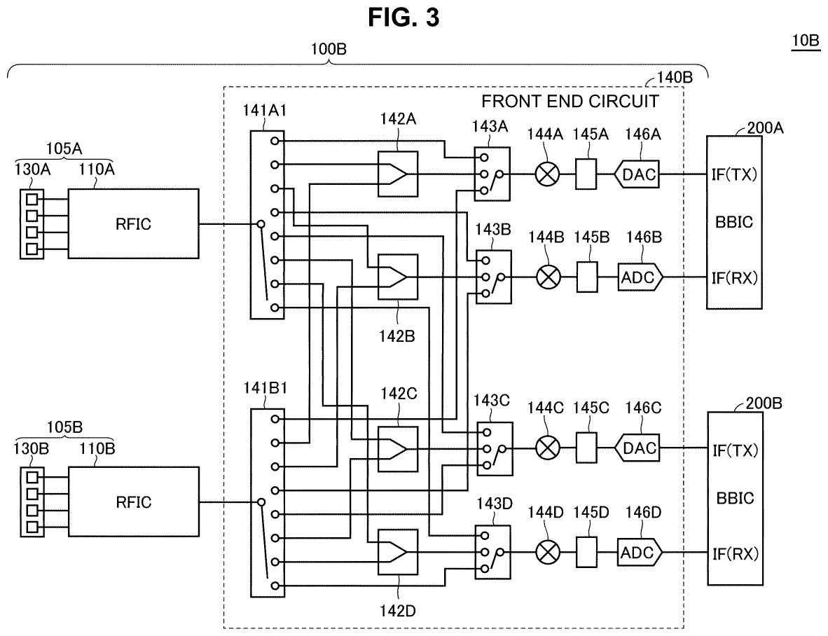

FIG. 3 is a block diagram of a communication apparatus 10B in which an antenna module 100B according to the third embodiment is used. The communication apparatus 10B includes BBICs 200A and 200B, which are baseband circuits, and the antenna module 100B. The antenna module 100B includes two radio frequency circuits 105A and 105B and a front end circuit 140B. The configurations of the radio frequency circuits 105A and 105B are similar to the configurations in the first embodiment, and detailed description of the configurations of the radio frequency circuits 105A and 105B will be omitted.

The BBICs 200A and 200B process signals at different intermediate frequencies. For example, the BBIC 200A processes an intermediate frequency corresponding to signals in a 28 GHz band, and the BBIC 200B processes an intermediate frequency corresponding to signals in a 39 GHZ band. In this case, in the individual antenna panels, an antenna element for 28 GHZ and an antenna element for 39 GHZ are disposed. Alternatively, the BBICs 200A and 200B may be configured to transmit signals with different contents in the same frequency band.

The front end circuit 140B includes switches 141A1, 141B1, and 143A to 143D, branching elements 142A to 142D, mixers 144A to 144D, filters 145A to 145D, DACs 146A and 146C, and ADCs 146B and 146D.

Each of the switches 141A1 and 141B1 is an SP8T switch and includes a common terminal and eight switching terminals. The switches 141A1 and 141B1 are provided in association with the radio frequency circuits 105A and 105B and the common terminals are connected to the corresponding RFICS.

Each of the branching elements 142A to 142D is configured to branch off into two paths, as with the branching elements 142A and 142B in the first embodiment, and includes a first terminal and second and third terminals that branch off from the first terminal.

The switch 143A, the mixer 144A, the filter 145A, and the DAC 146A form a circuit on a transmission side of the BBIC 200A. Furthermore, the switch 143C, the mixer 144C, the filter 145C, and the DAC 146C form a circuit on a transmission side of the BBIC 200B. The elements in the circuits mentioned above are similar to the switch 143A, the mixer 144A, the filter 145A, and the DAC 146A in the first embodiment, and detailed description of these elements will not be repeated.

The switch 143B, the mixer 144B, the filter 145B, and the ADC 146B form a circuit on a reception side of the BBIC 200A. Furthermore, the switch 143D, the mixer 144D, the filter 145D, and the ADC 146D form a circuit on a reception side of the BBIC 200B. The elements in the circuits mentioned above are similar to the switch 143B, the mixer 144B, the filter 145B, and the ADC 146B in the first embodiment, and detailed description of these elements will not be repeated.

In the front end circuit 140B, for each of the BBICs, a radio frequency circuit to be used for transmission and reception is selected using the switches 141A1, 141B1, and 143A to 143D and the branching elements 142A to 142D. A specific connection arrangement of the switches and the branching elements will be described below.

First, a circuit on the transmission side of the BBIC 200A will be described. The first switching terminal of the switch 143A on the transmission side is directly connected to the first switching terminal of the switch 141A1. Furthermore, the third switching terminal of the switch 143A is directly connected to the first switching terminal of the switch 141B1. The second switching terminal of the switch 143A is connected to the first terminal of the branching element 142A. The second terminal of the branching element 142A is connected to the second switching terminal of the switch 141A1, and the third terminal of the branching element 142A is connected to the second switching terminal of the switch 141B1.

With the arrangement described above, by switching to the first switching terminals of the switches 143A and 141A1, a radio wave corresponding to a transmission signal from the BBIC 200A can be radiated only from the radio frequency circuit 105A. Furthermore, by switching to the third switching terminal of the switch 143A and switching to the first switching terminal of the switch 141B1, a radio wave corresponding to a transmission signal from the BBIC 200A can be radiated only from the radio frequency circuit 105B. Furthermore, by switching to the second switching terminal of the switch 143A and switching to the second switching terminals of the switches 141A1 and 141B1, a radio wave corresponding to a transmission signal from the BBIC 200A can be radiated from both the radio frequency circuits 105A and 105B.

Next, a circuit on the reception side of the BBIC 200A will be described. The first switching terminal of the switch 143B on the transmission side is directly connected to the fourth switching terminal of the switch 141A1. Furthermore, the third switching terminal of the switch 143B is directly connected to the fourth switching terminal of the switch 141B1. The second switching terminal of the switch 143B is connected to the first terminal of the branching element 142B. The second terminal of the branching element 142B is connected to the third switching terminal of the switch 141A1, and the third terminal of the branching element 142B is connected to the third switching terminal of the switch 141B1.

With the arrangement described above, by switching to the first switching terminal of the switch 143B and switching to the fourth switching terminal of the switch 141A1, a signal received at the radio frequency circuit 105A can be processed at the BBIC 200A. Furthermore, by switching to the third switching terminal of the switch 143B and switching to the fourth switching terminal of the switch 141B1, a signal received at the radio frequency circuit 105B can be processed at the BBIC 200A. Furthermore, by switching to the second switching terminal of the switch 143B and switching to the third switching terminals of the switches 141A1 and 141B1, signals received at both the radio frequency circuits 105A and 105B can be processed at the BBIC 200A.

Next, a circuit on the transmission side of the BBIC 200B will be described. The first switching terminal of the switch 143C on the transmission side is directly connected to the fifth switching terminal of the switch 141A1. Furthermore, the third switching terminal of the switch 143C is directly connected to the fifth switching terminal of the switch 141B1. The second switching terminal of the switch 143C is connected to the first terminal of the branching element 142C. The second terminal of the branching element 142C is connected to the sixth switching terminal of the switch 141A1, and the third terminal of the branching element 142C is connected to the sixth switching terminal of the switch 141B1.

With the arrangement described above, by switching to the first switching terminal of the switch 143C and switching to the fifth switching terminal of the switch 141A1, a radio wave corresponding to a transmission signal from the BBIC 200B can be radiated only from the radio frequency circuit 105A. Furthermore, by switching to the third switching terminal of the switch 143C and switching to the fifth switching terminal of the switch 141B1, a radio wave corresponding to a transmission signal from the BBIC 200B can be radiated only from the radio frequency circuit 105B. Furthermore, by switching to the second switching terminal of the switch 143C and switching to the sixth switching terminals of the switches 141A1 and 141B1, a radio wave corresponding to a transmission signal from the BBIC 200B can be radiated from both the radio frequency circuits 105A and 105B.

Next, a circuit on the reception side of the BBIC 200B will be described. The first switching terminal of the switch 143D on the transmission side is directly connected to the eighth switching terminal of the switch 141A1. Furthermore, the third switching terminal of the switch 143D is directly connected to the eighth switching terminal of the switch 141B1. The second switching terminal of the switch 143D is connected to the first terminal of the branching element 142D. The second terminal of the branching element 142D is connected to the seventh switching terminal of the switch 141A1, and the third terminal of the branching element 142D is connected to the seventh switching terminal of the switch 141B1.

With the arrangement described above, by switching to the first switching terminal of the switch 143D and switching to the eighth switching terminal of the switch 141A1, a signal received at the radio frequency circuit 105A can be processed at the BBIC 200B. Furthermore, by switching to the third switching terminal of the switch 143D and switching to the eighth switching terminal of the switch 141B1, a signal received at the radio frequency circuit 105B can be processed at the BBIC 200B. Furthermore, by switching to the second switching terminal of the switch 143D and switching to the seventh switching terminals of the switches 141A1 and 141B1, signals received at both the radio frequency circuits 105A and 105B can be processed at the BBIC 200B.

Thus, for each of the BBICs 200A and 200B, switching between a first state in which one of the radio frequency circuits 105A and 105B is used to perform transmission and reception and a second state in which both the radio frequency circuits 105A and 105B are used to perform transmission and reception can be performed.

In the case where the BBIC 200A performs transmission and reception only to and from the radio frequency circuit 105A, the BBIC 200B is able to perform transmission and reception only to and from the radio frequency circuit 105B. Similarly, in the case where the BBIC 200A performs transmission and reception only to and from the radio frequency circuit 105B, the BBIC 200B is able to perform transmission and reception only to and from the radio frequency circuit 105A.

That is, for example, in the case where the BBIC 200A transmits and receives a signal in the 28 GHz band and the BBIC 200B transmits and receives a signal in the 39 GHZ band, transmission and reception of signals in the same frequency band (28 GHz band or 39 GHz band) can be performed using both the radio frequency circuits 105A and 105B or transmission and reception of signals in different frequency bands can be performed using the radio frequency circuits 105A and 105B. Furthermore, transmission and reception of signals in one of the 28 GHz band and the 39 GHz band can be performed by using only one of the radio frequency circuits 105A and 105B.

With the arrangement described above, in an antenna module including a plurality of baseband circuits and a plurality of radio frequency circuits (antenna panels), switching between radio frequency circuits to be used for transmission and reception for each of the baseband circuits can be performed efficiently. Furthermore, since a transmission signal can be supplied only to a radio frequency circuit to be used for transmission, unwanted power consumption can be suppressed.

The “BBICs 200A and 200B” in the third embodiment correspond, as a whole, to a “baseband circuit” in the present disclosure, the “BBIC 200A” corresponds to a “first circuit”, and the “BBIC 200B” corresponds to a “second circuit.” The “switches 141A1 and 141B1” in the third embodiment correspond, as a whole, to a “first switch circuit” in the present disclosure, and the “switch 141A1” and the “switch 141B1” correspond to a “first switch” and a “second switch”, respectively, in the present disclosure. The “switches 143A to 143D” in the third embodiment correspond, as a whole, to a “second switch circuit” in the present disclosure, and the “switches 143A to 143D” correspond to a “first transmission switch”, a first reception switch”, a “second transmission switch”, and a “second reception switch”, respectively, in the present disclosure. The “branching elements 142A to 142D” in the third embodiment correspond, as a whole, to a “branching circuit” in the present disclosure, and the “branching elements 142A to 142D” correspond to “seventh to tenth branching elements”, respectively, in the present disclosure.

### Fourth Embodiment

In a fourth embodiment, a configuration for the case where four antenna panels and two baseband circuits are used to perform transmission and reception will be described.

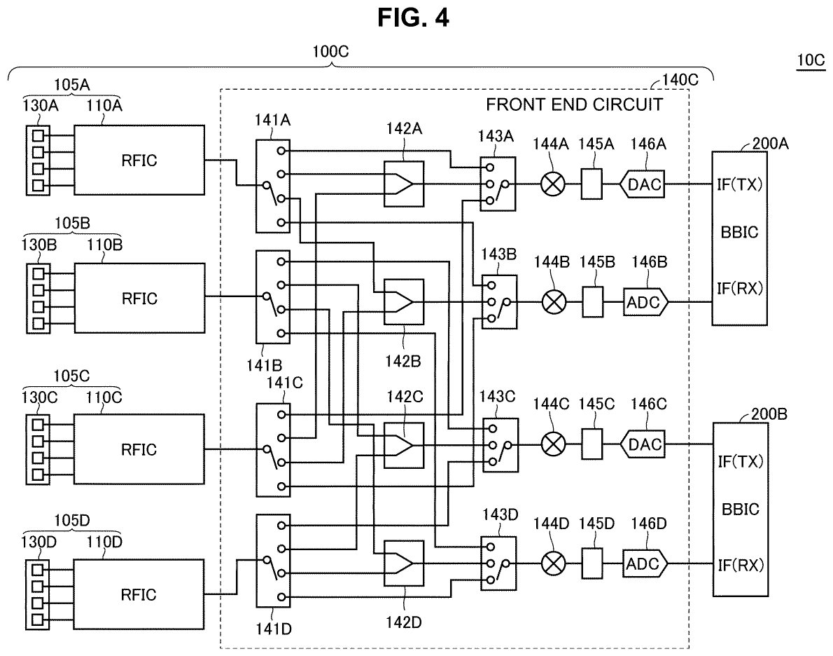

FIG. 4 is a block diagram of a communication apparatus 10C in which an antenna module 100C according to the fourth embodiment is used. The communication apparatus 10C includes BBICs 200A and 200B, which are baseband circuits, and the antenna module 100C. The antenna module 100C includes four radio frequency circuits 105A to 105D and a front end circuit 140C. The configurations of the radio frequency circuits 105A to 105D are similar to the configurations in the second embodiment, and detailed description of the configurations of the radio frequency circuits 105A to 105D will be omitted.

The front end circuit 140C is configured such that the switches 141A1 and 141B1 in the front end circuit 140B in the third embodiment are replaced by the switches 141A to 141D of the SPAT type, as in the second embodiment. Regarding the front end circuit 140C in FIG. 4, description of the same elements as those of the front end circuit 140B will not be repeated.

The first switching terminal of the switch 143A on the transmission side of the BBIC 200A is directly connected to the first switching terminal of the switch 141A. Furthermore, the third switching terminal of the switch 143A is directly connected to the first switching terminal of the switch 141C. The second switching terminal of the switch 143A is connected to the first terminal of the branching element 142A. The second terminal of the branching element 142A is connected to the second switching terminal of the switch 141A, and the third terminal of the branching element 142A is connected to the second switching terminal of the switch 141C.

With the arrangement described above, by switching to the first switching terminals of the switches 143A and 141A, a radio wave corresponding to a transmission signal from the BBIC 200A can be radiated only from the radio frequency circuit 105A. Furthermore, by switching to the third switching terminal of the switch 143A and switching to the first switching terminal of the switch 141C, a radio wave corresponding to a transmission signal from the BBIC 200A can be radiated only from the radio frequency circuit 105C. Furthermore, by switching to the second switching terminal of the switch 143A and switching to the second switching terminals of the switches 141A and 141C, a radio wave corresponding to a transmission signal from the BBIC 200A can be radiated from both the radio frequency circuits 105A and 105C.

The first switching terminal of the switch 143B on the reception side of the BBIC 200A is directly connected to the fourth switching terminal of the switch 141A. Furthermore, the third switching terminal of the switch 143B is directly connected to the fourth switching terminal of the switch 141C. The second switching terminal of the switch 143B is connected to the first terminal of the branching element 142B. The second terminal of the branching element 142B is connected to the third switching terminal of the switch 141A, and the third terminal of the branching element 142B is connected to the third switching terminal of the switch 141C.

With the arrangement described above, by switching to the first switching terminal of the switch 143B and switching to the fourth switching terminal of the switch 141A, a signal received at the radio frequency circuit 105A can be processed at the BBIC 200A. Furthermore, by switching to the third switching terminal of the switch 143B and switching to the fourth switching terminal of the switch 141C, a signal received at the radio frequency circuit 105B can be processed at the BBIC 200A. Furthermore, by switching to the second switching terminal of the switch 143B and switching to the third switching terminals of the switches 141A and 141C, signals received at both the radio frequency circuits 105A and 105C can be processed at the BBIC 200A.

The first switching terminal of the switch 143C on the transmission side of the BBIC 200B is directly connected to the first switching terminal of the switch 141B. Furthermore, the third switching terminal of the switch 143C is directly connected to the first switching terminal of the switch 141D. The second switching terminal of the switch 143C is connected to the first terminal of the branching element 142C. The second terminal of the branching element 142C is connected to the second switching terminal of the switch 141B, and the third terminal of the branching element 142C is connected to the second switching terminal of the switch 141D.

With the arrangement described above, by switching to the first switching terminals of the switches 143C and 141B, a radio wave corresponding to a transmission signal from the BBIC 200B can be radiated only from the radio frequency circuit 105B. Furthermore, by switching to the third switching terminal of the switch 143C and switching to the first switching terminal of the switch 141D, a radio wave corresponding to a transmission signal from the BBIC 200B can be radiated only from the radio frequency circuit 105D. Furthermore, by switching to the second switching terminal of the switch 143C and switching to the second switching terminals of the switches 141B and 141D, a radio wave corresponding to a transmission signal from the BBIC 200B can be radiated from both the radio frequency circuits 105B and 105D.

The first switching terminal of the switch 143D on the reception side of the BBIC 200B is directly connected to the fourth switching terminal of the switch 141B. Furthermore, the third switching terminal of the switch 143D is directly connected to the fourth switching terminal of the switch 141D. The second switching terminal of the switch 143D is connected to the first terminal of the branching element 142D. The second terminal of the branching element 142D is connected to the third switching terminal of the switch 141B, and the third terminal of the branching element 142D is connected to the third switching terminal of the switch 141D.

With the arrangement described above, by switching to the first switching terminal of the switch 143D and switching to the fourth switching terminal of the switch 141B, a signal received at the radio frequency circuit 105B can be processed at the BBIC 200B. Furthermore, by switching to the third switching terminal of the switch 143D and switching to the fourth switching terminal of the switch 141D, a signal received at the radio frequency circuit 105D can be processed at the BBIC 200D. Furthermore, by switching to the second switching terminal of the switch 143D and switching to the third switching terminals of the switches 141B and 141D, signals received at both the radio frequency circuits 105B and 105D can be processed at the BBIC 200B.

With the arrangement described above, for the BBIC 200A, switching between a first state in which one of the radio frequency circuits 105A and 105C is used to perform transmission and reception and a second state in which both the radio frequency circuits 105A and 105C are used to perform transmission and reception can be performed. Furthermore, for the BBIC 200B, switching between a first state in which one of the radio frequency circuits 105B and 105D is used to perform transmission and reception and a second state in which both the radio frequency circuits 105B and 105D are used to perform transmission and reception can be performed.

The “switches 141A to 141D” in the fourth embodiment correspond, as a whole, to a “first switch circuit” in the present disclosure, and the “switches 141A to 141D” correspond to “first to fourth switches” in the present disclosure. The “switches 143A to 143D” in the fourth embodiment correspond, as a whole, to a “second switch circuit” in the present disclosure, and the “switches 143A to 143D” correspond to a “first transmission switch”, a first reception switch”, a “second transmission switch”, and a “second reception switch”, respectively, in the present disclosure. The “branching elements 142A to 142D” in the fourth embodiment correspond, as a whole, to a “branching circuit” in the present disclosure, and the “branching elements 142A to 142D” correspond to “twenty-first to twenty-fourth branching elements”, respectively, in the present disclosure.

### First Modification

The front end circuit according to the first embodiment with a configuration in which an intermediate frequency signal received from a baseband circuit is up-converted into a radio frequency signal and the radio frequency signal is transmitted using a switch circuit and a branching circuit to a desired radio frequency circuit has been described.

In a first modification, a configuration in which a baseband signal at a frequency lower than an intermediate frequency is received from a baseband circuit and a switch circuit and a branching circuit are used for the region of an intermediate frequency signal will be described.

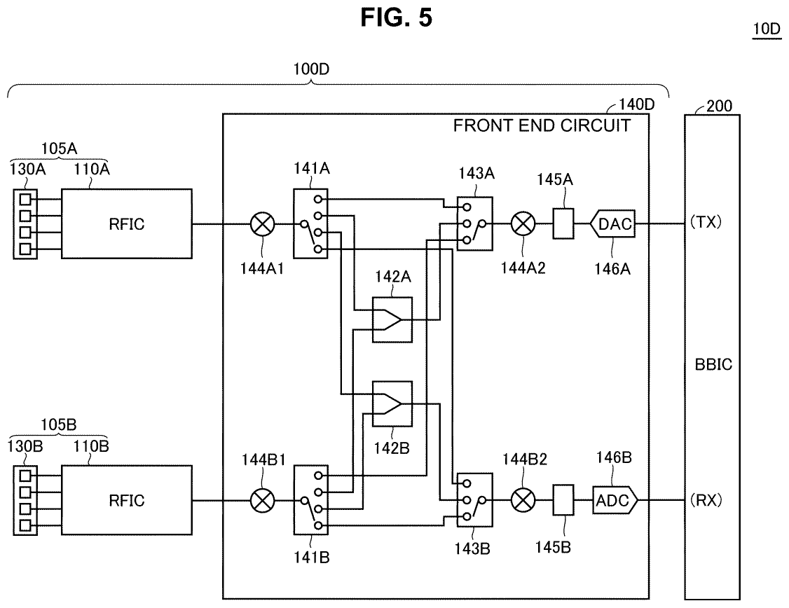

FIG. 5 is a block diagram of a communication apparatus 10D in which an antenna module 100D including a front end circuit 140D according to the first modification is used. Regarding the front end circuit 140D, the mixers 144A and 144B in the front end circuit 140 according to the first embodiment are replaced by mixers 144A2 and 144B2.

Furthermore, in the front end circuit 140D, a mixer 144A1 is disposed between the switch 141A and the RFIC 110A and a mixer 144B1 is disposed between the switch 141B and the RFIC 110B. In FIG. 5, description of the same elements as those in FIG. 1 will not be repeated.

Referring to FIG. 5, in the communication apparatus 10D according to the first modification, a signal is transmitted, using a baseband signal at a frequency lower than an intermediate frequency, between the front end circuit 140D and the BBIC 200. In the case of radiation of a radio wave, the front end circuit 140D up-converts, using the mixer 144A2, a baseband signal received from the BBIC 200 into an intermediate frequency signal. Then, as described above in the first embodiment, a signal path to a radio frequency circuit to be used for transmission is selected using the switches 141A, 141B, 143A, and 143B and the branching elements 142A and 142B. That is, in the front end circuit 140D, selection of a signal path is made in the region of an intermediate frequency signal. Then, the intermediate frequency signal is up-converted, using the mixer 144A1 or 144B1 into a radio frequency signal, and the radio frequency signal is transmitted to a corresponding radio frequency circuit.

In the case of reception of radio waves, reception signals of radio frequency signals received at the radio frequency circuits 105A and 105B are down-converted, using the corresponding mixers 144A1 and 144B1, into intermediate frequency signals. Then, in the region of an intermediate frequency signal, a signal or signals from one or both of the radio frequency circuits 105A and 105B is/are transmitted, using the switches 141A, 141B, 143A, and 143B and the branching elements 142A and 142B, to the switch 143B for reception. The mixer 144B2 down-converts the signal transmitted to the switch 143B into a baseband signal and transmits the baseband signal to a reception circuit of the BBIC 200.

In the front end circuit 140D with the configuration described above, intermediate frequency signals pass through a switching circuit including the switches 141A, 141B, 143A, and 143B and the branching elements 142A and 142B. In general, loss due to the length of a path in which a signal is transmitted increases as the frequency of a signal increases. Thus, by using an intermediate frequency signal in the switching circuit that tends to have a relatively long path length, signal loss can be reduced in the first modification, compared to the case where a radio frequency signal is used as in the first embodiment.

The “mixers 144A1 and 144B1” in the first modification correspond to a “first mixer” in a “first mixer circuit” in the present disclosure in the case of transmission and correspond to a “third mixer” in a “second mixer circuit” in the present disclosure in the case of reception. The “mixer 144A2” in the first modification corresponds to a “second mixer” in the “first mixer circuit” in the present disclosure. The “mixer 144B2” in the first modification corresponds to a “fourth mixer” in the “second mixer circuit” in the present disclosure.

### Second Modification

In a second modification, a configuration in which a switch circuit and a branching circuit are used for the region of a baseband signal will be described.

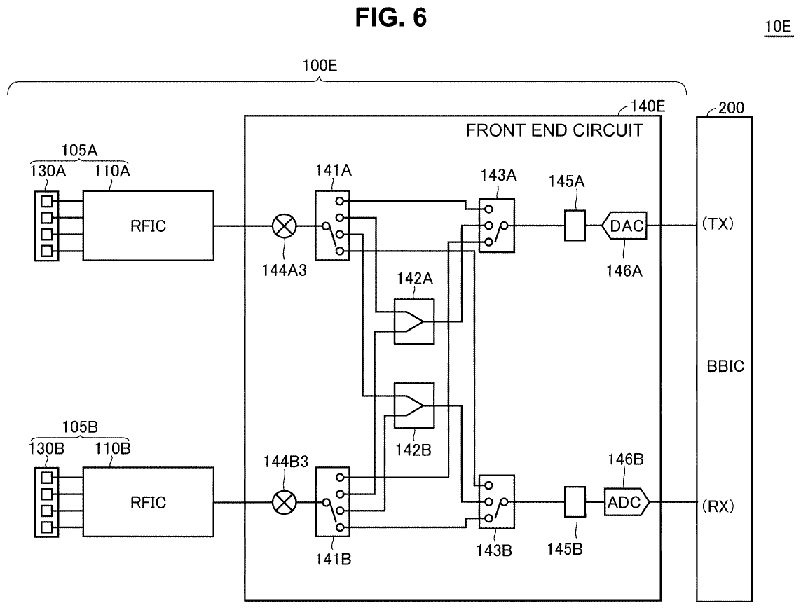

FIG. 6 is a block diagram of a communication apparatus 10E in which an antenna module 100E including a front end circuit 140E according to the second modification is used. In the front end circuit 140E, in place of the mixers 144A and 144B of the front end circuit 140 in the first embodiment, a mixer 144A3 is disposed between the switch 141A and the RFIC 110A, and a mixer 144B3 is disposed between the switch 141B and the RFIC 110B. In FIG. 6, description of the same elements as those in FIG. 1 will not be repeated.

Referring to FIG. 6, also in the communication apparatus 10E according to the second modification, a signal is transmitted, using a baseband signal at a frequency lower than an intermediate frequency, between the front end circuit 140E and the BBIC 200, as in the first modification. In the second modification, in the case of radiation of a radio wave, in the region of a baseband signal, selection of a signal path is made using the switches 141A, 141B, 143A, and 143B and the branching elements 142A and 142B. Then, the baseband signal is up-converted, using the mixer 144A3 or 144B3, into a radio frequency signal, and the radio frequency signal is transmitted to a corresponding radio frequency circuit.

In the case of reception of radio waves, reception signals of radio frequency signals received at the radio frequency circuits 105A and 105B are down-converted, using the corresponding mixers 144A3 and 144B3, into baseband signals. Then, in the region of a baseband signal, a signal or signals from one or both of the radio frequency circuits 105A and 105B is/are transmitted, using the switches 141A, 141B, 143A, and 143B and the branching elements 142A and 142B, to the switch 143B for reception, and eventually transmitted to the reception circuit of the BBIC 200.

In the front end circuit 140E according to the second modification, by using a baseband signal in the switching circuit that tends to have a relatively long path length, signal loss can be reduced compared to the case where a radio frequency signal is used as in the first embodiment and the case where an intermediate frequency signal is used as in the first modification.

The “mixers 144A3 and 144B3” in the second modification correspond to a “first mixer circuit” in the present disclosure in the case of transmission and correspond to a “second mixer circuit” in the present disclosure in the case of reception.

### Fifth Embodiment

In a fifth embodiment, a configuration in which features of the present disclosure are applied to the case of carrier aggregation (CA) that bundles signals in two different frequency bands that are adjacent to each other and performs transmission and reception of the signals will be described.

### First Example

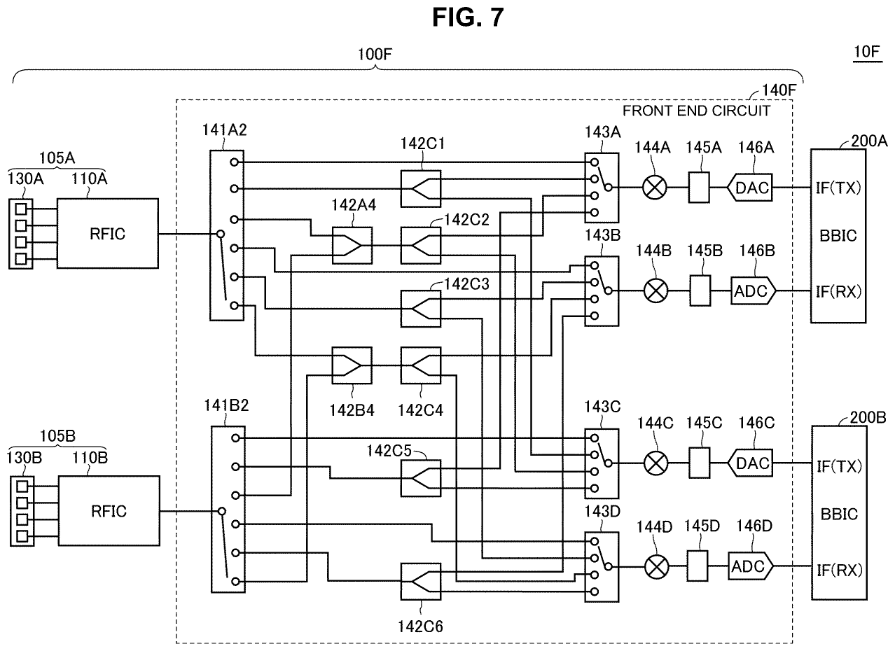

FIG. 7 is a block diagram of a communication apparatus 10F in which an antenna module 100F according to a first example of the fifth embodiment is used. The communication apparatus 10F is configured such that the front end circuit 140B in the communication apparatus 10B in FIG. 3 is replaced by a front end circuit 140F. In FIG. 7, description of the same elements as those in FIG. 3 will not be repeated.

In the front end circuit 140F, switches 141A2 and 141B2, in place of the switches 141A1 and 141B1 in the front end circuit 140B in FIG. 3, and branching elements 142A4, 142B4, and 142C1 to 142C6, in place of the branching elements 142A to 142D, are provided.

Each of the switches 141A2 and 141B2 is an SP6T switch and includes a common terminal and six switching terminals. The common terminal of the switch 141A2 is connected to the RFIC 110A. The common terminal of the switch 141B2 is connected to the RFIC 110B. Each of the branching elements 142A4, 142B4, and 142C1 to 142C6 includes a first terminal and second and third terminals that branch off from the first terminal, as with the branching elements 142A and 142B in FIG. 1.

First, a circuit on a transmission side will be described. The first switching terminal of the switch 143A on the transmission side of the BBIC 200A is directly connected to the first switching terminal of the switch 141A2. That is, by switching to the first switching terminals of the switches 143A and 141A2, a radio wave corresponding to a transmission signal from the BBIC 200A can be radiated only from the radio frequency circuit 105A.

The second switching terminal of the switch 143A is connected to the second terminal of the branching element 142C1. The second switching terminal of the switch 143C on the transmission side of the BBIC 200B is connected to the third terminal of the branching element 142C1. The first terminal of the branching element 142C1 is connected to the second switching terminal of the switch 141A2. That is, by switching to the second switching terminals of the switches 143A and 143C and switching to the second switching terminal of the switch 141A2, transmission signals from the BBICs 200A and 200B are combined together, and a radio wave corresponding to the combined transmission signal can be radiated only from the radio frequency circuit 105A.

The third switching terminal of the switch 143A is connected to the second terminal of the branching element 142C2. The third switching terminal of the switch 143C on the transmission side of the BBIC 200B is connected to the third terminal of the branching element 142C2. The first terminal of the branching element 142C2 is connected to the first terminal of the branching element 142A4. The second terminal of the branching element 142A4 is connected to the third switching terminal of the switch 141A2, and the third terminal of the branching element 142A4 is connected to the third switching terminal of the switch 141B2. That is, by switching to the third switching terminals of the switches 143A and 143C and switching to the third switching terminals of the switches 141A2 and 141B2, transmission signals from the BBICs 200A and 200B are combined together, and a radio wave corresponding to the combined transmission signal can be radiated from both the radio frequency circuits 105A and 105B.

The fourth switching terminal of the switch 143A is connected to the second terminal of the branching element 142C5. The fourth switching terminal of the switch 143C on the transmission side of the BBIC 200B is connected to the third terminal of the branching element 142C5. The first terminal of the branching element 142C5 is connected to the second switching terminal of the switch 141B2. That is, by switching to the fourth switching terminals of the switches 143A and 143C and switching to the second switching terminal of the switch 141B2, transmission signals from the BBICs 200A and 200B are combined together, and a radio wave corresponding to the combined transmission signal can be radiated only from the radio frequency circuit 105B.

The first switching terminal of the switch 143C on the transmission side of the BBIC 200B is connected to the first switching terminal of the switch 141B2. That is, by switching to the first switching terminals of the switches 143C and 141B2, a radio wave corresponding to a transmission signal from the BBIC 200B can be radiated only from the radio frequency circuit 105B.

Next, a circuit on a reception side will be described. The first switching terminal of the switch 143B on the reception side of the BBIC 200A is directly connected to the fourth switching terminal of the switch 141A2. That is, by switching to the first switching terminal of the switch 143A and switching to the fourth switching terminal of the switch 141A2, a reception signal received at the radio frequency circuit 105A can be processed at the BBIC 200A.

The second switching terminal of the switch 143B is connected to the second terminal of the branching element 142C3. The third terminal of the branching element 142C3 is connected to the second switching terminal of the switch 143D on the reception side of the BBIC 200B. The first terminal of the branching element 142C3 is connected to the fifth switching terminal of the switch 141A2. That is, by switching to the second switching terminals of the switch 143B and the switch 143D and switching to the fifth switching terminal of the switch 141A2, a reception signal received at the radio frequency circuit 105A can be processed at both the BBIC 200A and the BBIC 200B.

The third switching terminal of the switch 143B is connected to the second terminal of the branching element 142C4. The third terminal of the branching element 142C4 is connected to the third switching terminal of the switch 143D on the reception side of the BBIC 200B. The first terminal of the branching element 142C4 is connected to the first terminal of the branching element 142B4. The second terminal of the branching element 142B4 is connected to the sixth switching terminal of the switch 141A2, and the third terminal of the branching element 142B4 is connected to the sixth switching terminal of the switch 141B2. That is, by switching to the third switching terminals of the switch 143B and the switch 143D and switching to the sixth switching terminals of the switch 141A2 and the switch 141B2, reception signals received at the radio frequency circuits 105A and 105B can be processed at both the BBIC 200A and the BBIC 200B.

The fourth switching terminal of the switch 143B is connected to the second terminal of the branching element 142C6. The third terminal of the branching element 142C6 is connected to the fourth switching terminal of the switch 143D on the reception side of the BBIC 200B. The first terminal of the branching element 142C6 is connected to the fifth switching terminal of the switch 141B2. That is, by switching to the fourth switching terminals of the switch 143B and the switch 143D and switching to the fifth switching terminal of the switch 141B2, a reception signal received at the radio frequency circuit 105B can be processed at both the BBIC 200A and the BBIC 200B.

The first switching terminal of the switch 143D on the reception side of the BBIC 200B is directly connected to the fourth switching terminal of the switch 141B2. That is, by switching to the first switching terminal of the switch 143D and switching to the fourth switching terminal of the switch 141B2, a reception signal received at the radio frequency circuit 105B can be processed only at the BBIC 200B.

With the arrangement described above, in the case of transmission, signals from the BBICs 200A and 200B can be individually radiated or can be combined together and radiated from the radio frequency circuit 105A and/or the radio frequency circuit 105B. Furthermore, in the case of reception, signals received at the radio frequency circuits 105A and 105B can be individually processed or can be combined together/split and processed at the BBIC 200A and/or the BBIC 200B. Thus, carrier aggregation can be supported.

The “switches 141A2 and 141B2” in the first example of the fifth embodiment correspond, as a whole, to a “first switch circuit” in the present disclosure, and the “switch 141A2” and the “switch 141B2” correspond to a “first switch” and a “second switch”, respectively, in the present disclosure. The “branching elements 142A4, 142B4, and 142C1 to 142C6” in the first example correspond to “thirteenth to twentieth branching elements”, respectively, in the present disclosure.

### Second Example

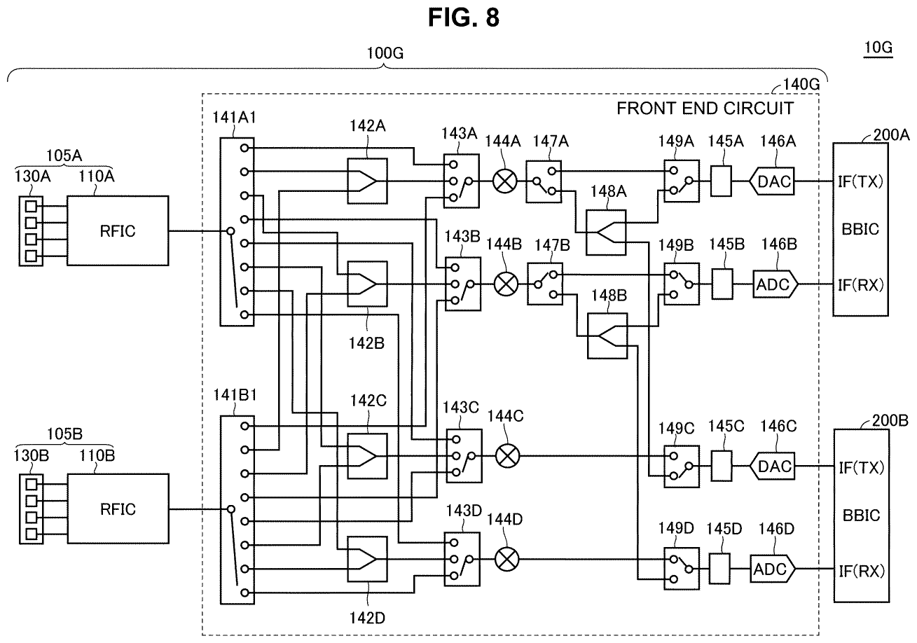

FIG. 8 is a block diagram of a communication apparatus 10G in which an antenna module 100G according to a second example of the fifth embodiment is used. The communication apparatus 10G is configured such that the front end circuit 140B in the communication apparatus 10B in FIG. 3 is replaced by a front end circuit 140G. In FIG. 8, description of the same elements as those in FIG. 3 will not be repeated.

The front end circuit 140G is configured such that a switch circuit and a branching circuit that are used to combine transmission signals from the BBICs 200A and 200B and to split reception signals received at the radio frequency circuits 105A and 105B are added between the mixers 144A to 144D and the filters 145A to 145D in the front end circuit 140B in FIG. 3. More specifically, the additional circuits mentioned above include switches 147A, 147B, and 149A to 149D and branching elements 148A and 148B.

Each of the switches 147A, 147B, and 149A to 149D is an SP2T switch and includes a common terminal and two switching terminals. Furthermore, each of the branching elements 148A and 148B includes a first terminal and second and third terminals that branch off from the first terminal, as with the branching elements 142A and 142B in FIG. 1.

First, a circuit on a transmission side will be described. The common terminal of the switch 149A is connected to the filter 145A on the transmission side of the BBIC 200A. The common terminal of the switch 149C is connected to the filter 145C on the transmission side of the BBIC 200B. Furthermore, the common terminal of the switch 147A is connected to the mixer 144A.

The first switching terminal of the switch 149A is connected to the first switching terminal of the switch 147A. The second switching terminal of the switch 149A is connected to the second terminal of the branching element 148A. The third terminal of the branching element 148A is connected to the second switching terminal of the switch 149C. The first terminal of the branching element 148A is connected to the second switching terminal of the switch 147A. The first switching terminal of the switch 149C is connected to the mixer 144C.

That is, by switching to the first switching terminals of the switches 147A and 149A, a transmission signal from the BBIC 200A is transmitted only to the switch 143A. As described above with reference to FIG. 3, by appropriate switching of the switches 141A1, 141B1, and 143A, a radio wave corresponding to the transmission signal can be radiated from the radio frequency circuit 105A and/or the radio frequency circuit 105B. Furthermore, by switching to the first switching terminal of the switch 149C, a transmission signal from the BBIC 200B is transmitted to the switch 143C. By appropriate switching of the switches 141A1, 141B1, and 143C, a radio wave corresponding to the transmission signal can be radiated from the radio frequency circuit 105A and/or the radio frequency circuit 105B. In the case where switching to the first switching terminals of both the switches 149A and 149C is performed, a radio wave corresponding to a transmission signal from the BBIC 200A can be radiated from one of the radio frequency circuit 105A and the radio frequency circuit 105B and a radio wave corresponding to a transmission signal from the BBIC 200B can be radiated from the other one of the radio frequency circuit 105A and the radio frequency circuit 105B, based on settings of the switches 141A1, 141B1, 143A, and 143C.

In contrast, by switching to the second switching terminals of all the switches 147A, 149A, and 149C, a transmission signal from the BBIC 200A and a transmission signal from the BBIC 200B are combined together by the branching element 148A, and the combined signal is transmitted to the switch 143A. Then, by appropriate switching of the switches 141A1, 141B1, and 143A, a radio wave corresponding to the combined transmission signal is radiated from the radio frequency circuit 105A and/or the radio frequency circuit 105B.

Next, a circuit on a reception side will be described. The common terminal of the switch 149B is connected to the filter 145B on the reception side of the BBIC 200A. The common terminal of the switch 149D is connected to the filter 145D on the reception side of the BBIC 200B. Furthermore, the common terminal of the switch 147B is connected to the mixer 144B.

The first switching terminal of the switch 149B is connected to the first switching terminal of the switch 147B. The second switching terminal of the switch 149B is connected to the second terminal of the branching element 148B. The third terminal of the branching element 148B is connected to the second switching terminal of the switch 149D. The first terminal of the branching element 148B is connected to the second switching terminal of the switch 147B. The first switching terminal of the switch 149D is connected to the mixer 144D.

That is, by switching to the first switching terminals of the switches 147B and 149B, a reception signal transmitted to the switch 143B can be processed only at the BBIC 200A. Furthermore, by switching to the first switching terminal of the switch 149D, a reception signal transmitted to the switch 143D can be processed only at the BBIC 200B.

In contrast, by switching to the second switching terminals of all the switches 147B, 149B, and 149D, a reception signal transmitted to the switch 143B can be processed at both the BBICs 200A and BBIC 200B.

As described above with reference to FIG. 3, by appropriate switching of the switches 141A1, 141B1, 143B, and 143D, reception signals received at the radio frequency circuit 105A and the radio frequency circuit 105B can be transmitted to one or both of the switches 143B and 143D. Thus, based on the combination of switching of the switches 141A1, 141B1, 143B, and 143D and switching of the switches 147B, 149B, and 149D, a combination of a reception signal received at a radio frequency circuit and a BBIC that processes the reception signal can be made in a desired manner.

With the arrangement described above, in the case of transmission, signals from the BBICs 200A and 200B can be individually radiated or can be combined together and radiated from the radio frequency circuit 105A and/or the radio frequency circuit 105B. Furthermore, in the case of reception, signals received at the radio frequency circuits 105A and 105B can be individually processed or can be combined together/split and processed at the BBIC 200A and/or the BBIC 200B. Thus, carrier aggregation can be supported.

The “switches 147A and 147B” in the second example correspond, as a whole, to a “third switch circuit” in the present disclosure, and the “switches 147A and 147B” correspond to a “fifth switch” and a “sixth switch”, respectively, in the present disclosure. The “switches 149A to 149D” in the second example correspond, as a whole, to a “fourth switch circuit” in the present disclosure, and the “switches 149A to 149D” correspond to “seventh to tenth switches”, respectively, in the present disclosure. The “branching elements 148A and 148B” in the second example correspond, as a whole, to a “second branching circuit” in the present disclosure, and the “branching element 148A” and the “branching element 148B” correspond to an “eleventh branching element” and a “twelfth branching element”, respectively, in the present disclosure.

### Third Modification

Although carrier aggregation based on a combination of signals conforming to the same communication standards is assumed in the first example and the second example described above, the configuration described above is also applicable to a combination of signals based on different communication standards or different communication techniques.

For example, a combination of a signal conforming to communication standards for WiGig and a signal conforming to communication standards for 5G FR2-2 can be made. Alternatively, a combination of data communication using WiGig and location measurement information using RADAR (Radio Detecting and Ranging) may be made.

In the case where a combination of data communication and location measurement information is made, by measuring the location of equipment as a communication target and setting the beam direction of a radio wave to the direction of the location, the quality of communication can be improved under a condition where the communication target travels.

### Aspects

(First aspect) An antenna module according to an aspect transmits and receives a signal to and from a baseband circuit. The antenna module includes a plurality of radio frequency circuits each including at least one antenna element, and a front end circuit that transfers a signal between the baseband circuit and the plurality of radio frequency circuits. The front end circuit includes a first switch circuit that is connected to the plurality of radio frequency circuits, a second switch circuit that is connected to the baseband circuit, and a first branching circuit that is connected between the first switch circuit and the second switch circuit. The plurality of radio frequency circuits include a first radio frequency circuit and a second radio frequency circuit. The front end circuit is configured to, by switching of the first switch circuit and the second switch circuit, switch between a first state in which a signal is transferred between one of the first radio frequency circuit and the second radio frequency circuit and the baseband circuit and a second state in which a signal is transferred between both the first radio frequency circuit and the second radio frequency circuit and the baseband circuit.
(Second aspect) In the antenna module according to the first aspect, the first switch circuit includes a first switch that is connected to the first radio frequency circuit and a second switch that is connected to the second radio frequency circuit. The baseband circuit includes a transmission circuit and a reception circuit. The second switch circuit includes a transmission switch that is connected to the transmission circuit of the baseband circuit and a reception switch that is connected to the reception circuit of the baseband circuit.
(Third aspect) In the antenna module according to the second aspect, the first branching circuit includes a first branching element and a second branching element. Each of the first branching element and the second branching element includes a first terminal, and a second terminal and a third terminal that branch off from the first terminal. The first terminal of the first branching element is connected to the transmission switch. The second terminal and the third terminal of the first branching element are connected to the first switch and the second switch, respectively. The first terminal of the second branching element is connected to the reception switch. The second terminal and the third terminal of the second branching element are connected to the first switch and the second switch, respectively.
(Fourth aspect) In the antenna module according to the third aspect, each of the transmission switch and the reception switch is directly connected to the first switch and the second switch.
(Fifth aspect) In the antenna module according to the second aspect, the plurality of radio frequency circuits further include a third radio frequency circuit and a fourth radio frequency circuit. The first switch circuit further includes a third switch that is connected to the third radio frequency circuit and a fourth switch that is connected to the fourth radio frequency circuit.
(Sixth aspect) In the antenna module according to the fifth aspect, the first branching circuit includes first to fourth branching elements. Each of the first to fourth branching elements includes a first terminal, and a second terminal and a third terminal that branch off from the first terminal. The first terminal of the first branching element is connected to the transmission switch. The second terminal and the third terminal of the first branching element are connected to the first switch and the second switch, respectively. The first terminal of the second branching element is connected to the reception switch. The second terminal and the third terminal of the second branching element are connected to the first switch and the second switch, respectively. The first terminal of the third branching element is connected to the transmission switch. The second terminal and the third terminal of the third branching element are connected to the third switch and the fourth switch, respectively. The first terminal of the fourth branching element is connected to the reception switch. The second terminal and the third terminal of the fourth branching element are connected to the third switch and the fourth switch, respectively.
(Seventh aspect) In the antenna module according to the sixth aspect, the first branching circuit further includes a fifth branching element and a sixth branching element. Each of the fifth branching element and the sixth branching element includes a fourth terminal, and fifth to eighth terminals that branch off from the fourth terminal. The fourth terminal of the fifth branching element is connected to the transmission switch. The fifth to eighth terminals of the fifth branching element are connected to the first to fourth switches, respectively. The fourth terminal of the sixth branching element is connected to the reception switch. The fifth to eighth terminals of the sixth branching element are connected to the first to fourth switches, respectively.
(Eighth aspect) In the antenna module according to the first aspect, the baseband circuit includes a first circuit and a second circuit each including a transmission circuit and a reception circuit. The first switch circuit includes a first switch that is connected to the first radio frequency circuit and a second switch that is connected to the second radio frequency circuit. The second switch circuit includes a first transmission switch that is connected to the transmission circuit of the first circuit, a first reception switch that is connected to the reception circuit of the first circuit, a second transmission switch that is connected to the transmission circuit of the second circuit, and a second reception switch that is connected to the reception circuit of the second circuit. The first branching circuit includes seventh to tenth branching elements. Each of the seventh to tenth branching elements includes a first terminal, and a second terminal and a third terminal that branch off from the first terminal. The first terminal of the seventh branching element is connected to the first transmission switch. The second terminal and the third terminal of the seventh branching element are connected to the first switch and the second switch, respectively. The first terminal of the eighth branching element is connected to the first reception switch. The second terminal and the third terminal of the eighth branching element are connected to the first switch and the second switch, respectively. The first terminal of the ninth branching element is connected to the second transmission switch. The second terminal and the third terminal of the ninth branching element are connected to the first switch and the second switch, respectively. The first terminal of the tenth branching element is connected to the second reception switch. The second terminal and the third terminal of the tenth branching element are connected to the first switch and the second switch, respectively.
(Ninth aspect) In the antenna module according to the eighth aspect, each of the switches included in the second switch circuit is directly connected to the first switch and the second switch.
(Tenth aspect) In the antenna module according to the eighth or ninth aspect, the front end circuit further includes a third switch circuit, a fourth switch circuit, and a second branching circuit. The third switch circuit includes a fifth switch and a sixth switch that are connected to the first transmission switch and the first reception switch, respectively. The fourth switch circuit includes a seventh switch and an eighth switch that are connected to the transmission circuit and the reception circuit, respectively, of the first circuit and a ninth switch and a tenth switch that are connected to the transmission circuit and the reception circuit, respectively, of the second circuit. The second branching circuit includes an eleventh branching element and a twelfth branching element. Each of the eleventh branching element and the twelfth branching element includes a first terminal, and a second terminal and a third terminal that branch off from the first terminal. The first terminal of the eleventh branching element is connected to the fifth switch. The second terminal and the third terminal of the eleventh branching element are connected to the seventh switch and the ninth switch, respectively. The first terminal of the twelfth branching element is connected to the sixth switch. The second terminal and the third terminal of the twelfth branching element are connected to the eighth switch and the tenth switch, respectively.
(Eleventh aspect) In the antenna module according to the tenth aspect, the fifth switch is connected to the seventh switch. The sixth switch is connected to the eighth switch. The ninth switch is connected to the second transmission switch. The tenth switch is connected to the second reception switch.
(Twelfth aspect) In the antenna module according to the first aspect, the baseband circuit includes a first circuit and a second circuit each including a transmission circuit and a reception circuit. The first switch circuit includes a first switch that is connected to the first radio frequency circuit and a second switch that is connected to the second radio frequency circuit. The second switch circuit includes a first transmission switch that is connected to the transmission circuit of the first circuit, a first reception switch that is connected to the reception circuit of the first circuit, a second transmission switch that is connected to the transmission circuit of the second circuit, and a second reception switch that is connected to the reception circuit of the second circuit. The first branching circuit includes thirteenth to twentieth branching elements. Each of the thirteenth to twentieth branching elements includes a first terminal, and a second terminal and a third terminal that branch off from the first terminal. The first terminal of the thirteenth branching element is connected to the first terminal of the sixteenth branching element. The second terminal and the third terminal of the thirteenth branching element are connected to the first switch and the second switch, respectively. The first terminal of the fourteenth branching element is connected to the first terminal of the eighteenth branching element. The second terminal and the third terminal of the fourteenth branching element are connected to the first switch and the second switch, respectively. The first terminal of the fifteenth branching element is connected to the first switch. The second terminal and the third terminal of the fifteenth branching element are connected to the first transmission switch and the second transmission switch, respectively. The second terminal and the third terminal of the sixteenth branching element are connected to the first transmission switch and the second transmission switch, respectively. The first terminal of the seventeenth branching element is connected to the first switch. The second terminal and the third terminal of the seventeenth branching element are connected to the first reception switch and the second reception switch, respectively. The second terminal and the third terminal of the eighteenth branching element are connected to the first reception switch and the second reception switch, respectively. The first terminal of the nineteenth branching element is connected to the second switch. The second terminal and the third terminal of the nineteenth branching element are connected to the first transmission switch and the second transmission switch, respectively. The first terminal of the twentieth branching element is connected to the second switch. The second terminal and the third terminal of the twentieth branching element are connected to the first reception switch and the second reception switch, respectively.
(Thirteenth aspect) In the antenna module according to the twelfth aspect, the first transmission switch and the first reception switch are connected to the first switch. The second transmission switch and the second reception switch are connected to the second switch.
(Fourteenth aspect) In the antenna module according to the first aspect, the baseband circuit includes a first circuit and a second circuit each including a transmission circuit and a reception circuit. The plurality of radio frequency circuits further include a third radio frequency circuit and a fourth radio frequency circuit. The first switch circuit includes first to fourth switches that are connected to the first to fourth radio frequency circuits, respectively. The second switch circuit includes a first transmission switch that is connected to the transmission circuit of the first circuit, a first reception switch that is connected to the reception circuit of the first circuit, a second transmission switch that is connected to the transmission circuit of the second circuit, and a second reception switch that is connected to the reception circuit of the second circuit. The first branching circuit includes twenty-first to twenty-fourth branching elements. Each of the twenty-first to twenty-fourth branching elements includes a first terminal, and a second terminal and a third terminal that branch off from the first terminal. The first terminal of the twenty-first branching element is connected to the first transmission switch. The second terminal and the third terminal of the twenty-first branching element are connected to the first switch and the third switch, respectively. The first terminal of the twenty-second branching element is connected to the first reception switch. The second terminal and the third terminal of the twenty-second branching element are connected to the first switch and the third switch, respectively. The first terminal of the twenty-third branching element is connected to the second transmission switch. The second terminal and the third terminal of the twenty-third branching element are connected to the second switch and the fourth switch, respectively. The first terminal of the twenty-fourth branching element is connected to the second reception switch. The second terminal and the third terminal of the twenty-fourth branching element are connected to the second switch and the fourth switch, respectively.
(Fifteenth aspect) In the antenna module according to the fourteenth aspect, each of the first transmission switch and the first reception switch is directly connected to the first switch and the third switch. Each of the second transmission switch and the second reception switch is directly connected to the second switch and the fourth switch.
(Sixteenth aspect) In the antenna module according to the first aspect, the front end circuit further includes a first mixer circuit that is used to up-convert a transmission signal from the baseband circuit and a second mixer circuit that is used to down-convert reception signals from the plurality of radio frequency circuits.
(Seventeenth aspect) In the antenna module according to the sixteenth aspect, the first mixer circuit and the second mixer circuit are connected between the baseband circuit and the second switch circuit.
(Eighteenth aspect) In the antenna module according to the sixteenth aspect, the first mixer circuit and the second mixer circuit are connected between the plurality of radio frequency circuits and the first switch circuit.
(Nineteenth aspect) In the antenna module according to the sixteenth aspect, the baseband circuit includes a transmission circuit and a reception circuit. The second switch circuit includes a transmission switch that is connected to the transmission circuit of the baseband circuit and a reception switch that is connected to the reception circuit of the baseband circuit. The first mixer circuit includes a first mixer that is connected between the plurality of radio frequency circuits and the first switch circuit and a second mixer that is connected between the transmission circuit of the baseband circuit and the transmission switch. The second mixer circuit includes a third mixer that is connected between the plurality of radio frequency circuits and the first switch circuit and a fourth mixer that is connected between the reception circuit of the baseband circuit and the reception switch.
(Twentieth aspect) In the antenna module according to any one of the first to nineteenth aspects, each of the plurality of radio frequency circuits includes an array antenna including a plurality of antenna elements.
(Twenty-first aspect) In the antenna module according to any one of the first to nineteenth aspects, each of the plurality of radio frequency circuits includes a single antenna element.
(Twenty-second aspect) A front end circuit according to an aspect transfers a signal between a baseband circuit and a plurality of radio frequency circuits. The front end circuit includes a first switch circuit that is connected to the plurality of radio frequency circuits, a second switch circuit that is connected to the baseband circuit, and a first branching circuit that is connected between the first switch circuit and the second switch circuit. The plurality of radio frequency circuits include a first radio frequency circuit and a second radio frequency circuit. The front end circuit is configured to, by switching of the first switch circuit and the second switch circuit, switch between a first state in which a signal is transferred between one of the first radio frequency circuit and the second radio frequency circuit and the baseband circuit and a second state in which a signal is transferred between both the first radio frequency circuit and the second radio frequency circuit and the baseband circuit.

The embodiments disclosed herein are to be considered in all respects to be illustrative and not restrictive. The scope of the present disclosure is defined by the claims, rather than the embodiments described above, and is intended to include any modifications within the scope and meaning equivalent to the scope of the claims.

### REFERENCE SIGNS LIST

10, 10A to 10G communication apparatus, 100, 100A to 100G antenna module, 105, 105A to 105D radio frequency circuit, 110A to 110D RFIC, 111A to 111H, 113A to 113H, 141A to 141D, 141A1, 141A2, 141B1, 141B2, 143A to 143D, 147A, 147B, 149A to 149D switch, 112AR to 112HR low noise amplifier, 112AT to 112HT power amplifier, 114A to 114H attenuator, 115A to 115H phase shifter, 116A, 116B signal combiner/splitter, 120 antenna apparatus, 121 antenna element, 130, 130A to 130D dielectric substrate, 140, 140A to 140G front end circuit, 142A to 142D, 142A1 to 142A4, 142B1 to 142B4, 142C1 to 142C6, 148A, 148B branching element, 144A to 144D, 144A1 to 144A3, 144B1 to 144B3 mixer, 145A to 145D filter, 200A, 200B BBIC.

1. An antenna module that transmits and receives a signal to and from a baseband circuit, the antenna module comprising:
a plurality of radio frequency circuits each including at least one antenna element; and
a front end circuit that transfers a signal between the baseband circuit and the plurality of radio frequency circuits,
wherein the front end circuit includes
a first switch circuit that is connected to the plurality of radio frequency circuits,
a second switch circuit that is connected to the baseband circuit, and
a first branching circuit that is connected between the first switch circuit and the second switch circuit,
wherein the plurality of radio frequency circuits include a first radio frequency circuit and a second radio frequency circuit, and
wherein the front end circuit is configured to, by switching of the first switch circuit and the second switch circuit, switch between a first state in which a signal is transferred between one of the first radio frequency circuit and the second radio frequency circuit and the baseband circuit and a second state in which a signal is transferred between both the first radio frequency circuit and the second radio frequency circuit and the baseband circuit.

2. The antenna module according to claim 1,
wherein the first switch circuit includes
a first switch that is connected to the first radio frequency circuit, and
a second switch that is connected to the second radio frequency circuit,
wherein the baseband circuit includes a transmission circuit and a reception circuit, and
wherein the second switch circuit includes
a transmission switch that is connected to the transmission circuit of the baseband circuit, and
a reception switch that is connected to the reception circuit of the baseband circuit.

3. The antenna module according to claim 2,
wherein the first branching circuit includes a first branching element and a second branching element,
wherein each of the first branching element and the second branching element includes a first terminal, and a second terminal and a third terminal that branch off from the first terminal,
wherein the first terminal of the first branching element is connected to the transmission switch,
wherein the second terminal and the third terminal of the first branching element are connected to the first switch and the second switch, respectively,
wherein the first terminal of the second branching element is connected to the reception switch, and
wherein the second terminal and the third terminal of the second branching element are connected to the first switch and the second switch, respectively.

4. The antenna module according to claim 3, wherein each of the transmission switch and the reception switch is directly connected to the first switch and the second switch.

5. The antenna module according to claim 2,
wherein the plurality of radio frequency circuits further include a third radio frequency circuit and a fourth radio frequency circuit, and
wherein the first switch circuit further includes
a third switch that is connected to the third radio frequency circuit, and
a fourth switch that is connected to the fourth radio frequency circuit.

6. The antenna module according to claim 5,
wherein the first branching circuit includes first to fourth branching elements,
wherein each of the first to fourth branching elements includes a first terminal, and a second terminal and a third terminal that branch off from the first terminal,
wherein the first terminal of the first branching element is connected to the transmission switch,
wherein the second terminal and the third terminal of the first branching element are connected to the first switch and the second switch, respectively,
wherein the first terminal of the second branching element is connected to the reception switch,
wherein the second terminal and the third terminal of the second branching element are connected to the first switch and the second switch, respectively,
wherein the first terminal of the third branching element is connected to the transmission switch,
wherein the second terminal and the third terminal of the third branching element are connected to the third switch and the fourth switch, respectively,
wherein the first terminal of the fourth branching element is connected to the reception switch, and wherein the second terminal and the third terminal of the fourth branching element are connected to the third switch and the fourth switch, respectively.

7. The antenna module according to claim 6,
wherein the first branching circuit further includes a fifth branching element and a sixth branching element,
wherein each of the fifth branching element and the sixth branching element includes a fourth terminal, and fifth to eighth terminals that branch off from the fourth terminal,
wherein the fourth terminal of the fifth branching element is connected to the transmission switch,
wherein the fifth to eighth terminals of the fifth branching element are connected to the first to fourth switches, respectively,
wherein the fourth terminal of the sixth branching element is connected to the reception switch, and
wherein the fifth to eighth terminals of the sixth branching element are connected to the first to fourth switches, respectively.

8. The antenna module according to claim 1,
wherein the baseband circuit includes a first circuit and a second circuit each including a transmission circuit and a reception circuit,
wherein the first switch circuit includes
a first switch that is connected to the first radio frequency circuit, and
a second switch that is connected to the second radio frequency circuit,
wherein the second switch circuit includes
a first transmission switch that is connected to the transmission circuit of the first circuit,
a first reception switch that is connected to the reception circuit of the first circuit,
a second transmission switch that is connected to the transmission circuit of the second circuit, and
a second reception switch that is connected to the reception circuit of the second circuit,
wherein the first branching circuit includes seventh to tenth branching elements,
wherein each of the seventh to tenth branching elements includes a first terminal, and a second terminal and a third terminal that branch off from the first terminal,
wherein the first terminal of the seventh branching element is connected to the first transmission switch,
wherein the second terminal and the third terminal of the seventh branching element are connected to the first switch and the second switch, respectively,
wherein the first terminal of the eighth branching element is connected to the first reception switch,
wherein the second terminal and the third terminal of the eighth branching element are connected to the first switch and the second switch, respectively,
wherein the first terminal of the ninth branching element is connected to the second transmission switch,
wherein the second terminal and the third terminal of the ninth branching element are connected to the first switch and the second switch, respectively,
wherein the first terminal of the tenth branching element is connected to the second reception switch, and
wherein the second terminal and the third terminal of the tenth branching element are connected to the first switch and the second switch, respectively.

9. The antenna module according to claim 8, wherein each of the switches included in the second switch circuit is directly connected to the first switch and the second switch.

10. The antenna module according to claim 9,
wherein the front end circuit further includes
a third switch circuit and a fourth switch circuit, and
a second branching circuit,
wherein the third switch circuit includes a fifth switch and a sixth switch that are connected to the first transmission switch and the first reception switch, respectively,
wherein the fourth switch circuit includes
a seventh switch and an eighth switch that are connected to the transmission circuit and the reception circuit, respectively, of the first circuit, and
a ninth switch and a tenth switch that are connected to the transmission circuit and the reception circuit, respectively, of the second circuit,
wherein the second branching circuit includes an eleventh branching element and a twelfth branching element,
wherein each of the eleventh branching element and the twelfth branching element includes a first terminal, and a second terminal and a third terminal that branch off from the first terminal,
wherein the first terminal of the eleventh branching element is connected to the fifth switch,
wherein the second terminal and the third terminal of the eleventh branching element are connected to the seventh switch and the ninth switch, respectively,
wherein the first terminal of the twelfth branching element is connected to the sixth switch, and
wherein the second terminal and the third terminal of the twelfth branching element are connected to the eighth switch and the tenth switch, respectively.

11. The antenna module according to claim 10,
wherein the fifth switch is connected to the seventh switch,
wherein the sixth switch is connected to the eighth switch,
wherein the ninth switch is connected to the second transmission switch, and
wherein the tenth switch is connected to the second reception switch.

12. The antenna module according to claim 1,
wherein the baseband circuit includes a first circuit and a second circuit each including a transmission circuit and a reception circuit,
wherein the first switch circuit includes
a first switch that is connected to the first radio frequency circuit, and
a second switch that is connected to the second radio frequency circuit,
wherein the second switch circuit includes
a first transmission switch that is connected to the transmission circuit of the first circuit,
a first reception switch that is connected to the reception circuit of the first circuit,
a second transmission switch that is connected to the transmission circuit of the second circuit, and
a second reception switch that is connected to the reception circuit of the second circuit,
wherein the first branching circuit includes thirteenth to twentieth branching elements,
wherein each of the thirteenth to twentieth branching elements includes a first terminal, and a second terminal and a third terminal that branch off from the first terminal,
wherein the first terminal of the thirteenth branching element is connected to the first terminal of the sixteenth branching element,
wherein the second terminal and the third terminal of the thirteenth branching element are connected to the first switch and the second switch, respectively,
wherein the first terminal of the fourteenth branching element is connected to the first terminal of the eighteenth branching element,
wherein the second terminal and the third terminal of the fourteenth branching element are connected to the first switch and the second switch, respectively,
wherein the first terminal of the fifteenth branching element is connected to the first switch,
wherein the second terminal and the third terminal of the fifteenth branching element are connected to the first transmission switch and the second transmission switch, respectively,
wherein the second terminal and the third terminal of the sixteenth branching element are connected to the first transmission switch and the second transmission switch, respectively,
wherein the first terminal of the seventeenth branching element is connected to the first switch,
wherein the second terminal and the third terminal of the seventeenth branching element are connected to the first reception switch and the second reception switch, respectively,
wherein the second terminal and the third terminal of the eighteenth branching element are connected to the first reception switch and the second reception switch, respectively,
wherein the first terminal of the nineteenth branching element is connected to the second switch,
wherein the second terminal and the third terminal of the nineteenth branching element are connected to the first transmission switch and the second transmission switch, respectively,
wherein the first terminal of the twentieth branching element is connected to the second switch, and
wherein the second terminal and the third terminal of the twentieth branching element are connected to the first reception switch and the second reception switch, respectively.

13. The antenna module according to claim 1,
wherein the baseband circuit includes a first circuit and a second circuit each including a transmission circuit and a reception circuit,
wherein the plurality of radio frequency circuits further include a third radio frequency circuit and a fourth radio frequency circuit,
wherein the first switch circuit includes first to fourth switches that are connected to the first to fourth radio frequency circuits, respectively,
wherein the second switch circuit includes
a first transmission switch that is connected to the transmission circuit of the first circuit,
a first reception switch that is connected to the reception circuit of the first circuit,
a second transmission switch that is connected to the transmission circuit of the second circuit, and
a second reception switch that is connected to the reception circuit of the second circuit,
wherein the first branching circuit includes twenty-first to twenty-fourth branching elements,
wherein each of the twenty-first to twenty-fourth branching elements includes a first terminal, and a second terminal and a third terminal that branch off from the first terminal,
wherein the first terminal of the twenty-first branching element is connected to the first transmission switch,
wherein the second terminal and the third terminal of the twenty-first branching element are connected to the first switch and the third switch, respectively,
wherein the first terminal of the twenty-second branching element is connected to the first reception switch,
wherein the second terminal and the third terminal of the twenty-second branching element are connected to the first switch and the third switch, respectively,
wherein the first terminal of the twenty-third branching element is connected to the second transmission switch,
wherein the second terminal and the third terminal of the twenty-third branching element are connected to the second switch and the fourth switch, respectively,
wherein the first terminal of the twenty-fourth branching element is connected to the second reception switch, and
wherein the second terminal and the third terminal of the twenty-fourth branching element are connected to the second switch and the fourth switch, respectively.

14. The antenna module according to claim 13,
wherein each of the first transmission switch and the first reception switch is directly connected to the first switch and the third switch, and
wherein each of the second transmission switch and the second reception switch is directly connected to the second switch and the fourth switch.

15. The antenna module according to claim 1, wherein the front end circuit further includes
a first mixer circuit that is used to up-convert a transmission signal from the baseband circuit, and
a second mixer circuit that is used to down-convert reception signals from the plurality of radio frequency circuits.

16. The antenna module according to claim 15, wherein the first mixer circuit and the second mixer circuit are connected between the baseband circuit and the second switch circuit.

17. The antenna module according to claim 15, wherein the first mixer circuit and the second mixer circuit are connected between the plurality of radio frequency circuits and the first switch circuit.

18. The antenna module according to claim 15,
wherein the baseband circuit includes a transmission circuit and a reception circuit,
wherein the second switch circuit includes
a transmission switch that is connected to the transmission circuit of the baseband circuit, and
a reception switch that is connected to the reception circuit of the baseband circuit,
wherein the first mixer circuit includes a first mixer that is connected between the plurality of radio frequency circuits and the first switch circuit and a second mixer that is connected between the transmission circuit of the baseband circuit and the transmission switch, and
wherein the second mixer circuit includes a third mixer that is connected between the plurality of radio frequency circuits and the first switch circuit and a fourth mixer that is connected between the reception circuit of the baseband circuit and the reception switch.

19. The antenna module according to claim 1, wherein each of the plurality of radio frequency circuits includes an array antenna including a plurality of antenna elements.

20. A front end circuit that transfers a signal between a baseband circuit and a plurality of radio frequency circuits, the front end circuit comprising:
a first switch circuit that is connected to the plurality of radio frequency circuits;
a second switch circuit that is connected to the baseband circuit; and
a first branching circuit that is connected between the first switch circuit and the second switch circuit,
wherein the plurality of radio frequency circuits include a first radio frequency circuit and a second radio frequency circuit, and
wherein the front end circuit is configured to, by switching of the first switch circuit and the second switch circuit, switch between a first state in which a signal is transferred between one of the first radio frequency circuit and the second radio frequency circuit and the baseband circuit and a second state in which a signal is transferred between both the first radio frequency circuit and the second radio frequency circuit and the baseband circuit.
